(19) United States
(12) Patent Application Publication
(10) Pub. No.: US 2011/0282621 A1
(43) Pub. Date: Nov. 17, 2011

(54) REMOTE MONITORING

(75) Inventors: Alexander George Simpson, Surrey (GB); Vincent Andrei Handerek, Essex (GB); Leslie Charles Laycock, Essex (GB); Hywel John Mcardle, Essex (GB); Andrew Graham McCarthy, Essex (GB); Christophe Arthur Paul Boulet, Essex (GB)

(73) Assignee: BAE SYSTEMS plc, London, Greater London (GB)

(21) Appl. No.: 12/918,450

(22) PCT Filed: Feb. 18, 2009
(86) PCT No.: PCT/GB09/50157

§ 371 Date: Aug. 19, 2010

(30) Foreign Application Priority Data
Feb. 20, 2008 (GB) 0803058.7
May 7, 2008 (EP) 08275012.6

(51) Int. Cl. G06F 15/00; G06F 17/30

(52) U.S. Cl. 702/149; 235/377

(57) ABSTRACT

An apparatus and method are provided for monitoring, remotely, information relating to the motion of at least one moving object. The apparatus comprises: means for illuminating a retro-reflective data carrier mounted on each moving object, in particular when the moving object is located at a predetermined monitoring position; means for detecting, in optical signals returned by the retro-reflective data carrier, data representing a timing trigger and data representing an identifier for the at least one moving object; timer means responsive to a timing trigger detected at the predetermined monitoring position to trigger a timer associated with a detected identifier; and an output to provide timing information associated with the detected identifier, and hence relating to the at least one moving object at the predetermined monitoring position. The timing information may be used to derive relative ordering, relative timing or speeds of moving objects, for example.

This invention relates to remote monitoring of the motion of an object and in particular, but not exclusively, to a determination of identity and timing information relating to the motion of one or more objects at one or more predetermined monitoring positions by remote interrogation of a data carrier carried by the object.

It is known to use one or more optical retro-reflectors attached to a target for the purpose of remotely tracking the target, for example a container in a freight depot or a part in a manufacturing process. A laser is used to illuminate the retro-reflectors and a receiver detects the optical return signals. A number of retro-reflectors may be used to determine the position of the target and a barcode within the retro-reflector may be read remotely and used to identify the target. U.S. Pat. No. 6,017,125 describes several types of optical retro-reflector and associated optical scanning apparatus for use in tracking multiple targets in three dimensions.

From a first aspect, the present invention resides in a monitoring apparatus for determining, remotely, information relating to the motion of at least one of a plurality of moving objects, comprising:

illuminating means for illuminating a retro-reflective data carrier mounted on said at least one moving object when said at least one moving object is located at a predetermined monitoring position;

detecting means for detecting, in optical signals returned by said retro-reflective data carrier, data representing a timing trigger and data representing an identifier for said at least one moving object;

timer means responsive to the detection of said timing trigger by said detecting means to associate a time with the detection of said timing trigger and thereby derive timing information in respect of a detected identifier; and

an output to provide said timing information associated with said detected identifier, and hence relating to said at least one moving object at said predetermined monitoring position.

The apparatus according to this first aspect of the present invention may be used to monitor the motion of one or more different moving objects. A different timer may be triggered and associated with each distinctly identified object to provide timing information for each object at one or more predetermined monitoring positions. This timing information may be used to derive a number of different pieces of information about the motion of one moving object or the relative motion of a number of different moving objects passing through such monitoring positions.

In a preferred application of the present invention, the data carrier may be attached to one or more bicycles moving around a cycle track, e.g. a velodrome, during training or racing. Timing information generated on detection of timing triggers for each distinctly identified bicycle as it moves past a predetermined position on the track, e.g. the finish line, may be used in a number of ways. For example, timing information may be used to calculate average speeds per lap or portion of a lap or to provide time gaps between bicycles, in addition to information on the relative ordering of a number of bicycles at the predetermined position on the track.

The present invention according to this first aspect is able to achieve a heightened degree of accuracy in the timing information captured for a moving object at one or more predetermined monitoring positions. Advantageously, the present invention provides a timing trigger data sequence on the data carrier that is separate from and preferably shorter than other fixed or variable length data sequences, such as the identifier and checksum data, that also need to be detected as the host bicycle passes a monitoring position. On detection, the timing trigger may trigger a timer before the identifier has been read. Alternatively, all the signal returns from the data carrier may be time-stamped by the timer means with timing signals, for example at 1 ms intervals, and the position of the timing trigger portion of the returned signals may be used to accurately determine the time at which a corresponding part of the moving object passed through the monitoring position. A short timing trigger on the same or a different retro-reflective data carrier may be more accurately aligned to a physical part of the moving object than the longer identification data sequence or other data carried by a data carrier.

In one preferred embodiment of the present invention, the retro-reflective data carrier is arranged, when mounted on the at least one moving object, so that data representing the timing trigger are detectable by the detecting means separately from data representing the identifier for the object. This may be achieved for example by positioning the data on the data carrier or data carriers so that the timing trigger may be detected first, an instant before data for the identifier. This enables a more precise and consistent trigger to be presented to the timer means. This may be particularly important if the present invention is also used for determining finishing positions of competitors in a sporting event where a more precise measurement is required of the instant in time that the competitor crosses the finishing line. The timing trigger may be aligned more precisely to that instant if presented separately and before other data in the optical return signals from an illuminated retro-reflective data carrier.

In a preferred implementation, the retro-reflective data carrier comprises a retro-reflective barcode. Preferably, the illuminating means comprise a laser arranged to provide a fixed and substantially planar light field at the predetermined position and, in use, the retro-reflective data carrier is illuminated as the object passes through the light field. It is further preferred that the retro-reflective data carrier is oriented such that data represented in the returned optical signals are detectable sequentially as the object moves through the light field.

A fixed light field is preferred, rather than a scanning beam, as this may contribute to greater timing accuracy at the monitoring position. In particular, a substantially planar light field of the order of 0.5 mm wide is preferred. However, a scanning beam may be used in the present invention where the required timing accuracy permits, or for example at a subset of monitoring positions where more than one monitoring position is provided.

In a preferred sports application of the present invention, the light field may be coincident with the “start” line or the “finish” line of a sports event. Light fields may also be generated at one or more other intermediate positions to enable timing information to be generated for each participant at each intermediate position to enable their individual or relative motion to be monitored more closely.

Preferably the monitoring apparatus further comprises means for determining the relative ordering at the predetermined monitoring position of a plurality of moving objects each having one of the retro-reflective data carriers mounted thereon and each carrying a different identifier. It is further preferred that the monitoring apparatus comprises means for determining the relative timing of each of a plurality of moving objects at the predetermined monitoring position.

Where monitoring at multiple predetermined monitoring positions is required, in the monitoring apparatus according to this first aspect of present invention, the illumination means further comprise means for illuminating at a plurality of predetermined monitoring positions and the timer means are responsive to a timing trigger detected at each of the plurality of predetermined monitoring positions to trigger a timer associated with an identifier detected at the respective predetermined monitoring position.

On the basis of timing information generated in respect of one or more predetermined monitoring positions, the monitoring apparatus preferably further comprises means for determining the speed of the at least one moving object. If the object is moving around a closed loop, the average speed may be determined from the known loop distance and timing information generated on each successive passage through a single predetermined monitoring position on the loop. More instantaneous speed measurements may be derived by using more than one monitoring position, ideally closely spaced.

In the preferred cycling application, the speed of each cycle may be determined individually over a predetermined section of the cycle track. In general, the path followed by each cyclist operating at speed will be the shortest path on the inside lane, enabling accurate speed measurements to be made over a distance of a few metres. Alternatively, average speeds over a full lap of a velodrome track may be measured. In general, the distance between the monitoring positions may be set to be as small or as large as necessary according to the accuracy required in measuring the speed, taking account also of the degree of unpredictability in the path followed by a moving object between those positions and the likely variation in its speed.

If the path followed by a moving object is a closed loop, the timer means may be triggered at a single monitoring position to toggle between starting and stopping on each consecutive detection of a timing trigger and a respective identifier.

From a second aspect, the present invention resides in a method for determining, remotely, information relating to the motion of at least one of a plurality of moving objects, comprising the steps of:

i) illuminating a retro-reflective data carrier mounted on the at least one moving object when the at least one moving object is located at a predetermined monitoring position;

ii) detecting, in optical signals returned by the retro-reflective data carrier, data representing a timing trigger and, separately, data representing an identifier for the at least one moving object;

iii) triggering a timer associated with the identifier for the at least one moving object at the predetermined monitoring position; and

iv) outputting timing information associated with the identifier, and hence with the at least one moving object, at the predetermined monitoring position.

Preferably, the method further comprises, at step ii), detecting the data sequentially.

Timing information provided by this method may be used, preferably, to determine the relative timing of each of a plurality of moving objects at the predetermined monitoring position.

Preferably, step i) of the method further comprises illuminating at a plurality of predetermined monitoring positions and step iii) further comprises triggering a timer when a timing trigger associated with a respective identifier is detected at each of the plurality of predetermined monitoring positions.

Timing information provided by this method may also be used, preferably, to determine the speed of the at least one moving object.

From a third aspect the present invention resides in a retro-reflective data carrier for use with a monitoring apparatus according to the first aspect of the present invention described above, comprising a optically retro-reflective barcode having data representing a timing trigger and data representing an identifier.

To increase the reliability in detecting the identifier, the retro-reflective barcode further comprises data representing a checksum for the identifier. The barcode may further comprise a start bit and a stop bit.

Where a retro-reflective data carrier according to this third aspect is to be used with a number of different moving objects, each data carrier carries a different identifier and preferably the data representing a timing trigger are the same for each data carrier.

From a fourth aspect, the present invention resides in an apparatus for determining, remotely, information relating to the identity and motion of at least one of a plurality of participants in a sports event, comprising means for interrogating, at one or more predetermined monitoring positions, a retro-reflective barcode mounted on said at least one participant moving through said one or more predetermined monitoring positions, wherein said barcode comprises data for triggering a timer in the apparatus at said one or more predetermined monitoring positions and data for identifying said at least one participant.

Preferably, the apparatus further comprises means for determining the relative ordering of a plurality of participants in the sports event at the one or more predetermined monitoring positions. The apparatus may also preferably comprise means for determining the speed of at least one of the plurality of participants on the basis of timing information generated at the one or more predetermined monitoring positions.

Whereas preferred embodiments of the present invention as described below are directed to monitoring the motion of participants in a sporting event, in particular cyclists on a closed-loop cycle track, it will be apparent to people of ordinary skill in the relevant art that preferred embodiments of the present invention may be applied to monitoring the motion of any moving object or objects with respect to one or more monitoring positions.

The invention will now be described in more detail by reference to an exemplary embodiment which is illustrated in the accompanying drawings, in which:

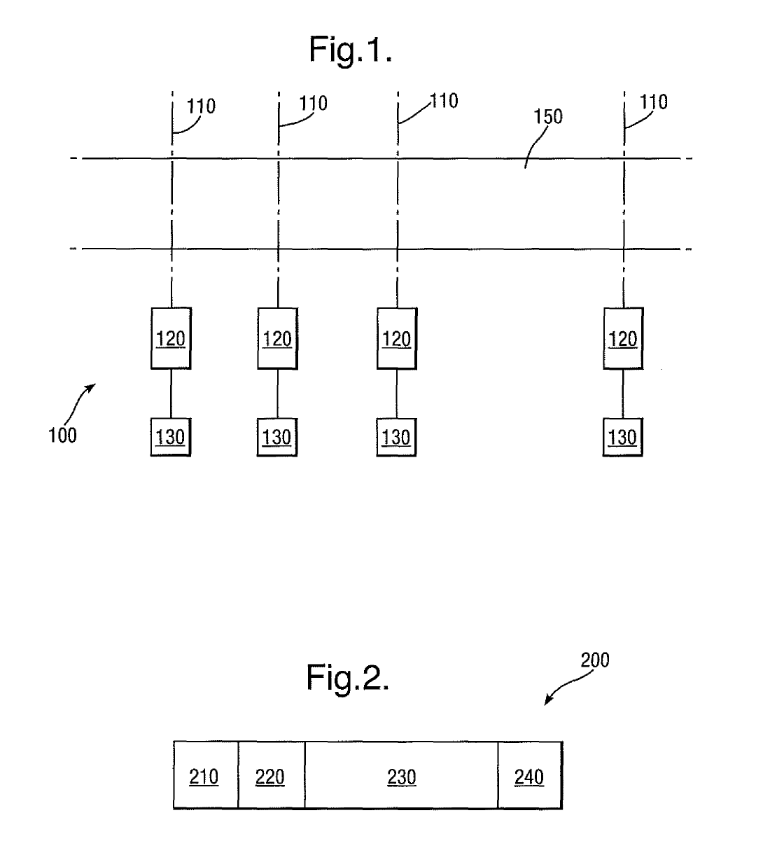

FIG. 1 is a schematic illustration of a speed monitoring apparatus in accordance with an embodiment of the invention;

FIG. 2 is a schematic diagram of a data carrier of the embodiment of FIG. 1;

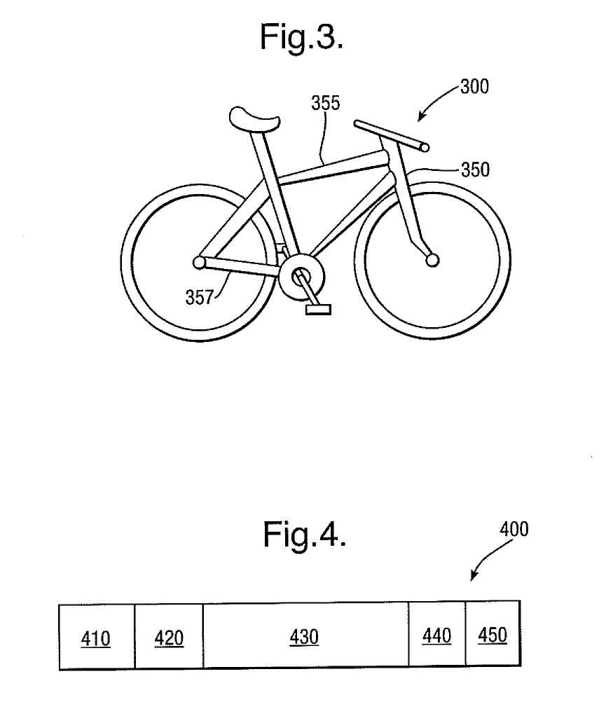

FIG. 3 illustrates the data carrier of FIG. 2 used on a bicycle;

FIG. 4 is a schematic illustration of a part of the data processing of the embodiment of FIG. 1;

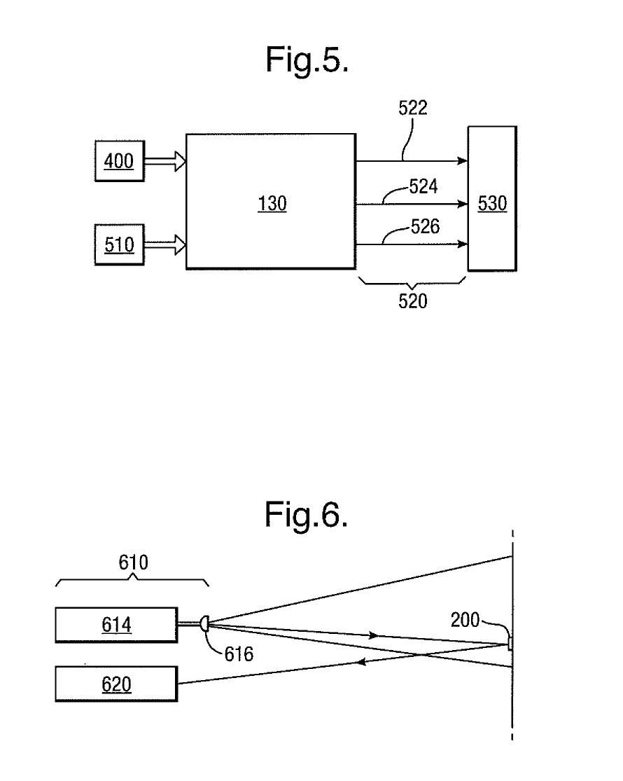

FIG. 5 is a schematic illustration of a further part of the data processing of the embodiment of FIG. 1; and

FIG. 6 is a schematic diagram of the illuminating and detecting means of the embodiment of FIG. 1.

An embodiment of the present invention is for use in monitoring one or more cyclists moving along a predefined course. In particular, the first embodiment enables the speed of a cyclist to be monitored. The course may, for example, be a velodrome or other track. FIG. 1 is an illustration of the monitoring apparatus 100 of the first embodiment. A number of predetermined monitoring positions, known as “gates”, are spaced out at predetermined intervals adjacent to a track 150. Each gate defines a position along the length of the track, as is illustrated in FIG. 1 by dashed lines 110. Each gate comprises an illumination means and a detector means, referenced together as 120 in FIG. 1, and processing means 130 operable to detect and identify a cyclist moving past the gate, and to communicate that information to a central base station (not shown). This information is used in combination with a timer to monitor the time elapsed between the cyclist passing through each gate such that the speed of the cyclist, time gaps and ordering of cyclists at each gate can be determined and recorded for later analysis.

The illumination means illuminate a data carrier mounted on the cyclist's bicycle. The data carrier is a spatially modulated retro-reflector. For example, the data carrier may be a bar code comprising a number of retro-reflective strips representing information bits. Such a data carrier can be fabricated from a strip of retro-reflective tape. As the cyclist passes through the gate, a modulated signal is reflected from the data carrier back to the detector means, which is mounted in close proximity to the illumination means. FIG. 2 illustrates a data carrier 200 that may be used in conjunction with the monitoring apparatus 100 of FIG. 1. The information on the data carrier comprises a start bit 210, a timing trigger 220, an identification word 230, and a stop bit 240. Preferably, the length of the data sequence for the timing trigger 220 is less than that of the identification word 230 and preferably the same timing trigger data sequence is used on all the data carriers to be used for a given cycling event.

The timing trigger 220 triggers the recording of the time at which the cyclist passes though the gate. This enables the processing of retrieved data to be stacked, facilitating the monitoring of a number of cyclists on the track simultaneously. Moreover, the accuracy of the time recording is improved since the time recorded will not be dependent on the amount of time taken for data processing: the time is recorded before passing the identification word 230 signal to data processing means for further analysis. The identification word 230 comprises sufficient information to identify the cyclist passing through the gate uniquely amongst those being monitored on the track. Start and stop bits 210 and 240 are present to start and stop the recording of the information at the gate, and are useful for the purposes of error reduction.

The data carrier 200 is carried on a part of the bicycle that, in normal use of the bicycle, will not be obscured from the side by any part of the cyclist's body. In the present embodiment, the data carrier 200 is approximately 70 mm long, and 15 mm tall. It is carried such that the information recorded on the data carrier 200 is effectively scanned by the movement of the bicycle through the (continuous) illumination means. FIG. 3 is a schematic illustration of a typical bicycle 300 comprising a frame 350. The data carrier 200 is carried on a portion of the frame 350, for example on the crossbar 355 to the fore of the position at which the cyclist's knees may cross the line-of-sight of the illumination means, or on that part of the frame 357 that links the crank 360 to the rear axle 370. Preferably, the data carrier is mounted at a position towards the front of the bicycle. In particular, the data carrier 200 may be mounted on the forks for the front wheel, in general the closest fixed position to the leading rim of the front wheel.

The processing means 130 at each gate records a data stream 400, illustrated schematically in FIG. 4, from the information that the detector means receives from the data carrier 200, adding a gate identifier code that uniquely identifies the gate and therefore the position of the cyclist on the track. In a preferred implementation, to enable offline processing of the data stream, a series of time stamps (not shown in FIG. 4) may be added to the data stream as data are detected, wherein the interval between time stamps is determined by the accuracy required in the timing of the cyclists. The data stream 400 thus comprises a start bit 410, a timing trigger 420, an identification word 430, a gate identifier 440, a stop bit 450 and associated time stamps. The position in time of the timing trigger 200, in particular, may be determined in offline processing of the data stream 400 by reference to the associated time stamps.

As is illustrated in FIG. 5, the processing means 130 at each gate receives and decouples the information recorded in the data stream 400. The processing means 130 also comprise a timer 510 that, triggered for example by detections of the start bit 210 in the data carrier 200, generates the time stamps to be associated with the received data stream 400 which enable the time to be determined, corresponding to receipt of the timing trigger 220, at which the cyclist passes through the gate. The processing means 130 then communicates information 520 comprising the time 522 at which the cyclist passed the gate, the identity of the gate 524, and the identity of the cyclist 526 to a central file store 530 held, for example, on a conventional computer. The information is communicated by any known wireless method. By recording the times at which the cyclist passes a number of the gates, the average speed of the cyclist can be calculated and monitored by the conventional file store 530. Other potentially useful training data, such as the cyclist's approximate acceleration over parts of the track, can also be calculated from the information recorded on the cyclist from three or more gates.

Provision of a timing trigger 220 on the data carrier 200 that is separate from other data on the data carrier 200 enables a more accurate determination of the instant at which a cyclist passes through a gate, not only because detection of the other data, such as the identification word 230, need not delay the trigger of a timing start or stop signal, but also because the timing trigger 220 of the data carrier 200 may be physically aligned with greater accuracy to that part of the bicycle which, according to the rules of cycle racing, determine finish time and position of a bicycle in a race. A data carrier of the preferred length of 70 mm allows for a range of possible timing positions along its length which may be greater than the potential interval between cyclists finishing a race. It may therefore be important, for finish line measurements in particular, to be able to determine timings and to determine relative position for a cyclist to a physical and temporal accuracy that is significantly smaller than the total length or scanning time respectively of a data carrier 200. Such accuracy may be achieved by means of the separate timing trigger 220 of the present invention.

In order to provide a substantially instantaneous estimate of the speed of a cyclist passing through a gate, a second timing trigger may be provided on a data carrier, or on a different data carrier mounted elsewhere on the bicycle, separated from the first timing trigger by at least the physical length of the identification word portion of the data carrier, so that a time interval may be determined between receipt of first and second timing triggers from the same bicycle. Knowing the physical distance between the first and second timing triggers as mounted on the bicycle, an estimate of the distance of the cyclist from the detector means 120, and the time interval between detection of the first and second timing triggers, the instantaneous speed of the cyclist may be estimated. Such information may be used, in particular, to more accurately determine the time at which certain parts of a bicycle pass through a gate, positioned for example at the finish line of a cycle race, irrespective of the actual position of mounting the data carrier 200 on the bicycle. For example, according to the rules of cycle racing, the finishing time and position of a bicycle are determined when the leading rim of the front wheel of the bicycle crosses the finishing line. It may be impractical to align the timing trigger of the data carrier with the leading rim of the front wheel, but if mounted a known distance behind the leading rim, a knowledge of the instantaneous speed of the bicycle at the time of detection of the timing trigger 220 may be used to calculate the time at which the leading rim of the front wheel crossed the finishing line, rather than take the time at which the timing trigger 220 itself crossed the line.

The illuminating and detecting means referenced 120 in FIG. 1 are illustrated more clearly in FIG. 6. As is shown in FIG. 6, illuminating means 610 are positioned closely adjacent to detector means 620. The illuminating means 610 comprise a laser 614, and a lens system 616. The laser 614 is a semiconductor laser operating at a wavelength of 635 nm and a power of 1 mW or less. Semiconductor lasers of this type are compact and robust, and have low drive-power requirements. Multiple lasers of different wavelengths may be used if required to detect multiple data carriers substantially simultaneously, or to help correct for the effects of bar code misalignment, caused for example by tilt of the cyclist. The laser 614 has a continuous wave output and its power is selected to comply with regulations for uncontrolled environments.

The lens system 616 comprises one or more cylindrical lenses arranged such that the laser beam diverges by a few degrees vertically, whilst remaining narrow in the horizontal plane. The beam thus forms an expanding curtain of light through which the cyclist travels on following the track. In the present embodiment, the beam at the expected position of the cyclist is approximately 1 m tall, and 0.5 mm wide. As will be appreciated by those skilled in the art, maintaining a narrow beamwidth in the horizontal plane enhances the accuracy and precision possible with a retro-reflective barcode data carrier. Preferably the lens system 616 is selected to substantially optimise the resolution of the system over the range of distances at which a data carrier 200 is expected to pass through the illuminating laser light, in particular by ensuring that the confocal distance of the lens system 616 is set so that the maximum width of the beam over that range of distances does not exceed a predetermined width, for example W√2, where W is the minimum width of the focussed beam (preferably 0.5 mm in the present embodiment). In particular, it is noted that the smaller the chosen minimum width of beam, W, and hence the finer the resolution that may be achieved, the shorter the range over which that resolution may be maintained for the detection of passing data carriers. Furthermore, the illuminating beam must be sufficiently tall to ensure that data carriers carried by cyclists at the likely variety of orientations will pass through it. Deployment of a fixed illuminating beam is preferable to using a scanning, well-focussed laser beam through the detection region because a scanning system would introduce an additional uncertainty into the time measurement.

The detecting means may be any known light sensitive receiver, such as a photodetector, operable to record a modulated light signal received from the data carrier as it passes. In the present embodiment, where the data carrier is mounted on a bicycle, it is anticipated that the data carrier will be moving at speeds of approximately 60 km/h.

As will be appreciated by those skilled in the art, the monitoring apparatus of the present invention can be used to monitor both the speed and acceleration of a single cyclist, or to measure the time intervals that elapse between successive cyclists passing through any particular gate. The apparatus is thus expected to find application in both training and race situations. Where multiple cyclists are to be monitored, it may be advantageous to use a multi-channel detector in order to facilitate the interrogation of the various data carriers passing through each gate. The above described embodiment is expected to provide a timing accuracy to within ±1 ms.

In a second embodiment of the invention, the data carrier 200 illustrated in FIG. 2 is modified to include a checksum digit for error-checking. The checksum digit is determined by summing the other digits on the data carrier. In all other respects, the second embodiment functions as described above.

Having described preferred embodiments of the present invention, it is noted that it is to be clearly understood that these embodiments are in all respects exemplary. Various equivalents and modifications to the above described embodiments will be readily apparent to those skilled in the art, and are possible without departing from the scope of the invention, which is defined in the accompanying claims. For example, it will be noted that, whilst in the above it has been described to use the monitoring apparatus for the monitoring of the motion of one or more cyclists, there will be many other sports in which the invention may find application, such as other athletic track sports. Moreover, whilst in the above it has been described to use a visible wavelength laser, it will be appreciated that a non-visible wavelength (for example a near infrared laser) may be advantageous in that less distraction would be caused to the athletes. Clearly, the wavelength must be selected to be sufficiently short to enable accurate reading of the barcode, whilst also being readily transmissible through the atmosphere. In such circumstances, the laser power would be kept to a minimum (at or less than 1 mW) in order to fulfil safety requirements. It would also be desirable to use a laser having a switchable visible wavelength for the purposes of alignment of the illumination means and the detector.

1. A monitoring apparatus for determining, remotely, information relating to the motion of at least one of a plurality of moving objects, comprising:
illuminating means for illuminating a retro-reflective data carrier mounted on said at least one moving object, in particular when said at least one moving object is located at a predetermined monitoring position;
detecting means for detecting, in optical signals returned by said retro-reflective data carrier, data representing a timing trigger and data representing an identifier for said at least one moving object;
timer means responsive to said timing trigger detected by said detecting means to associate a time with the detection of said timing trigger and thereby derive timing information in respect of a detected identifier; and
an output to provide said timing information associated with said detected identifier, and hence relating to said at least one moving object at said predetermined monitoring position.

2. (canceled)

3. The monitoring apparatus according to claim 1, wherein said retro-reflective data carrier comprises a retro-reflective barcode.

4. The monitoring apparatus according to claim 1, wherein said illuminating means comprise a laser arranged to provide a fixed and substantially planar light field at said predetermined monitoring position and wherein, in use, said retro-reflective data carrier is illuminated when said at least one moving object passes through said light field.

5. The monitoring apparatus according to claim 4, wherein said retro-reflective data carrier is oriented such that data represented in said returned optical signals are detectable sequentially.

6. The monitoring apparatus according to claim 1, further comprising means for determining the relative ordering at said predetermined monitoring position of a plurality of moving objects each having one of said retro-reflective data carriers mounted thereon and each having a different identifier.

7. The monitoring apparatus according to claim 1, further comprising means for determining the relative timing of each of a plurality of moving objects at said predetermined monitoring position.

8. The monitoring apparatus according to claim 1, wherein said illumination means further comprise means for illuminating at a plurality of predetermined monitoring positions and wherein said timer means are responsive to the detection of a timing trigger at any one of said plurality of predetermined monitoring positions to trigger a timer associated with an identifier detected at the respective monitoring position.

9. The monitoring apparatus according to claim 1, further comprising means for determining the speed of said at least one moving object on the basis of said timing information.

10. A method for determining, remotely, information relating to the motion of at least one of a plurality of moving objects, comprising the steps of:
i) illuminating a retro-reflective data carrier mounted on said at least one moving object when said at least one moving object is located at a predetermined monitoring position;
ii) detecting, in optical signals returned by said retro-reflective data carrier, data representing a timing trigger and, separately, data representing an identifier for said at least one moving object;
iii) triggering a timer associated with the detected identifier to thereby determine the time of detecting said data representing a timing trigger at said predetermined monitoring position; and
iv) outputting timing information associated with the identifier, and hence with said at least one moving object, at said predetermined monitoring position.

11. The method according to claim 10, wherein step ii) further comprises detecting said data sequentially.

12. The method according to claim 10, further comprising the step of determining the relative timing of each of a plurality of moving objects at said predetermined monitoring position.

13. The method according to claim 10, wherein step i) further comprises illuminating at a plurality of predetermined monitoring positions and step iii) further comprises triggering a timer when a timing trigger associated with a respective identifier is detected at each of said plurality of predetermined monitoring positions.

14. The method according to claim 10, further comprising the step of determining the speed of said at least one moving object on the basis of said timing information.

15. A retro-reflective data carrier for use with a monitoring apparatus according to claim 1, comprising a optically retro-reflective barcode having data representing a timing trigger and data representing an identifier.

16. The retro-reflective data carrier according to claim 15, wherein said barcode further comprises data representing a checksum for the identifier.

17. The retro-reflective data carrier according to claim 15, wherein said barcode further comprises a start bit and a stop bit.

18. The retro-reflective data carrier according to claim 15, for use with a plurality of moving objects, wherein each data carrier carries a different identifier and wherein the data representing a timing trigger are the same for each data carrier.

19. An apparatus for determining, remotely, information relating to the identity and motion of at least one of a plurality of participants in a sports event, comprising means for interrogating, at one or more predetermined monitoring positions, a retro-reflective barcode mounted on said at least one participant moving through said one or more predetermined monitoring positions, wherein said barcode comprises data for triggering a timer in the apparatus at said one or more predetermined monitoring positions and data for identifying said at least one participant.

20. The apparatus according to claim 19, further comprising means for determining the relative ordering of a plurality of participants in said sports event at said one or more predetermined monitoring positions.

21. The apparatus according to claim 19, further comprising means for determining the speed of at least one of said plurality of participants on the basis of timing information generated at said one or more predetermined monitoring positions.

22. (canceled)
